(19) United States
(12) Patent Application Publication
(10) Pub. No.: US 2006/0256592 A1
(43) Pub. Date: Nov. 16, 2006

(54) Electronic circuit

(76) Inventors: Yoshifumi Yoshida, Chiba-shi (JP); Fumiyasu Utsunomiya, Chiba-shi (JP)

Correspondence Address: BRINKS HOFER GILSON & LIONE, P.O. BOX 10395, CHICAGO, IL, 60610, US

(21) Appl. No.: 11/412,312

(22) Filed: Apr. 26, 2006

(30) Foreign Application Priority Data
Apr. 28, 2005 (JP) 2005-132520

(51) Int. Cl. H02M 3/18; H02M 7/00

(52) U.S. Cl. 363/59

(57) ABSTRACT

Provided is an electronic device having a booster circuit, in which a booster circuit and other circuits are prevented from being damaged even when a voltage that is equal to or higher than a standard voltage is inputted. The booster circuit for boosting an input voltage and outputting the boosted voltage has an input voltage limiter circuit for regulating an upper limit of an output voltage, and a booster circuit for boosting the input voltage at a fixed magnification by using a capacitor.

This application claims priority under 35 U.S.C. §119 to Japanese Patent Application No 2005-132520 filed Apr. 28, 2005, the entire content of which is hereby incorporated by reference.

### BACKGROUND OF THE INVENTION

1. Field of the Invention

The present invention relates to an electronic circuit, and more particularly, to a booster circuit for boosting an input voltage by using a capacitor.

2. Description of the Related Art

FIG. 4 shows a conventional booster circuit using a capacitor. The conventional booster circuit using the capacitor is constructed of MOSFETs 61 to 65 each connected with a diode, capacitors 67 to 71, and a clock generator circuit 72. The MOSFETs 61 to 65 each have a gate terminal connected to a drain terminal thereof and a source terminal connected to one electrode of each of the capacitors 67 to 71, and the other electrode of each of the capacitors 67 to 71 are connected to the clock generator circuit 72, thereby forming a circuit block. There are provided a plurality of circuit blocks thus formed, and the circuit blocks are connected in cascade. The source terminal of the MOSFET 65 is connected to a drain terminal of a MOSFET 66 and also connected to a gate electrode of the MOSFET 66, and a source terminal of the MOSFET 66 forms an output terminal of the conventional electronic circuit. The clock generator circuit 72 generates two pulse signals CLKA and CLKB that are different from each other in phase by 180 degrees. and supplies those pulse signals to one electrode of each of the capacitors 67 to 71.

The operation of the conventional booster circuit using the capacitor will be described in a state where no load is connected to an output terminal O2. Electric charges supplied to the input terminal 12 are charged in the capacitors 67 to 71 through the MOSFETs 61 to 65. In this situation, a potential Vc 67-1 of one of the electrodes of the capacitor 67 corresponds to a value obtained by subtracting Vf from an input voltage (input voltage)−Vf. Here, Vf is an amount of diode drop in the MOSFETs 61 to 66. When the pulse signal CLKA increases a potential Vc 67-2 of one of the electrodes of the capacitor 67 by a crest value (voltage) of the pulse signal, a potential Vc 67-1 of the other electrode of the capacitor 67 becomes a crest value which corresponds to a value obtained by adding a pulse signal to the input voltage from which Vf is subtracted (input voltage)−Vf+ (pulse signal). At this time, one of the electrodes of the capacitor 68 is connected to the pulse signal CLKB that is different from the pulse signal CLKA in phase by 180 degrees, so a potential Vc 68-2 of one of the electrodes of the capacitor 68 is at low level (a level close to a ground potential). Therefore, a potential V 68-1 of one of the electrodes of the capacitor 68 corresponds to a value of the diode drop amount of the MOSFET 62 with respect to the voltage sent from the capacitor 67, that is, ((input voltage)−Vf+ (crest value of pulse signal))−Vf.

In addition, when the pulse signal CLKB changes to be at a high level in a subsequent step, and a potential V 68-2 of one of the electrodes of the capacitor 68 is increased by the amount of crest value (voltage) of the pulse signal, the potential Vc 68-1 of the other electrode of the capacitor 68 becomes a crest value of ((input voltage)−Vf+ (crest value of pulse signal))−Vf+ pulse signal. In the subsequent operation, the above operation is repeated, and the electric charges that have been charged in the capacitor are increased in voltage and sent to a subsequent capacitor. In the electronic circuit shown in FIG. 6, the voltage of the output terminal O2 becomes (input voltage)−6×Vf+5× (crest value of pulse signal).

As another example having a circuit structure same as the one described above, JP 2005-057867 A discloses a circuit technique for preventing elements in the electronic circuit from being damaged.

In the above-mentioned electronic circuit, an input voltage value is boosted at a magnification that is determined by a circuit structure, regardless of whether the input voltage value is low or high. For that reason, for example, in the booster circuit shown in FIG. 4, when a MOSFET that is to be damaged at a voltage of 3 V is used, and 1 V is inputted to the input terminal 12, a potential Vc 69-1 of one of electrodes of the capacitor 69 exceeds 3V, which causes the MOSFETs 63 and 64 to be damaged. The conventional electronic circuit cannot be thus prevented from being damaged when a voltage that is more than an expected voltage is inputted as the input voltage.

To cope with the above drawback, up to now, the boost magnification or the number of steps of boost is controlled according to a voltage value that is applied to the input terminal 12 in such a manner that the internal MOSFETs do not reach a voltage that causes damage thereto, or the operation of the booster circuit is suspended when the voltage that is to cause damage is inputted to the internal MOSFETs.

### SUMMARY OF THE INVENTION

The present invention has been made in view of the drawbacks with the above conventional art, and therefore has an object to provide a voltage limiter circuit for outputting an input voltage as it is when a low voltage is inputted to an input terminal, and regulating an input voltage to a set value and outputting the input voltage thus regulated when a voltage that is higher than the set value is inputted to the input terminal, to thereby prevent a part of a booster circuit from exceeding a withstand voltage of MOSFETs in boosting operation and thus the elements can be prevented from being damaged.

In order to achieve the above object, according to the present invention, there is provided a booster circuit for boosting an input voltage at a fixed magnification by using a capacitor, in which an input voltage limiter circuit is provided for regulating an upper limit of the input voltage.

With the above structure, a part of the booster circuit can be prevented from exceeding the withstand voltage of the MOSFETs, and therefore the elements can be prevented from being damaged.

In the above electronic circuit according to the present invention, even when a voltage that is equal to or higher than the maximum voltage value is inputted to the electronic circuit, there is no case in which a voltage that is equal to or higher than the withstand voltage is applied to the MOSFETs to cause damage to the element in the booster circuit.

Also, even when the voltage that is equal to or higher than the maximum voltage value is inputted to the electronic circuit, the booster circuit continues to operate, which makes it possible to continuously drive a load.

Further, the input voltage limiter circuit uses the MOSFETs of the depletion type. Therefore, a constant voltage can be always applied to the booster circuit even if the input voltage reduces.

When an output voltage of the booster circuit that is included in the electronic circuit is going to be increased to a voltage that is equal to or higher than the withstand voltage of the MOSFET within the booster circuit, the output voltage limiter circuit operates, and therefore the element would not be damaged.

Even if the electronic circuit includes the booster circuit different in the boost magnification, due to the input voltage limiter circuit and the output voltage limiter circuit provided thereto, the voltage that is dealt with within the electronic circuit does not increase to be equal to or higher than the damage withstand voltage of the MOSFETs or the capacitors which constitute an interior of the electronic circuit.

The input terminal and the output terminal of the electronic circuit are each connected with the MOSFETs, which can suppress a current consumption when the electronic circuit is in a standby mode.

When the electronic circuit is in the standby mode, an operation of an oscillator circuit that serves as an operation source of the booster circuit is suspended, thereby suppressing the current consumption.

The booster circuit within the electronic circuit uses a clock having a crest value heightened by a second booster circuit and a level shifter circuit, which makes it possible to deliver large current supply performance with a small driver area. In other words, large driving performance can be obtained by a smaller chip area.

The output voltage limiter circuit has a switch for turning on/off the operation disposed therein, and therefore the power consumption can be suppressed even in the output voltage control circuit that is large in current consumption. In addition, the switch thus provided makes it possible for the booster circuit to be stably operated even if current consumption of the output voltage limiter circuit is large.

### BRIEF DESCRIPTION OF THE DRAWINGS

In the accompanying drawings:

FIG. 1 is a block diagram showing a schematic structure of an electronic circuit according to an embodiment of the present invention;

FIG. 2 is a circuit diagram showing a schematic structure of an input voltage limiter circuit according to the embodiment;

FIG. 3 is a circuit diagram showing a schematic structure of a constant voltage generator circuit according to the embodiment;

FIG. 4 is a circuit diagram showing a schematic structure of a conventional booster circuit;

FIG. 5 is a circuit diagram showing a schematic structure of a conventional booster circuit;

FIG. 6 is a graph showing an output characteristic of the input voltage limiter circuit according to the embodiment;

FIG. 7 is a circuit diagram showing a schematic structure of an electronic circuit according to another embodiment;

FIG. 8 is a circuit diagram showing a schematic structure of a booster circuit according to another embodiment of the present invention;

FIG. 9 is a circuit diagram showing a schematic structure of a second booster circuit according to another embodiment;

FIG. 10 is a circuit diagram showing a schematic structure of a level shifter circuit according to another embodiment;

FIG. 11 is a circuit diagram showing a schematic structure of an output voltage limiter circuit according to another embodiment;

FIG. 12 is a circuit diagram showing a schematic structure of a voltage detector circuit according to another embodiment;

FIG. 13 is a circuit diagram showing a schematic structure of a voltage detector circuit according to another embodiment; and

FIG. 14 is a circuit diagram showing a schematic structure of an application according to another embodiment.

### DETAILED DESCRIPTION OF THE PREFERRED EMBODIMENTS

### FIRST EMBODIMENT

Now, a description will be given in detail of preferred embodiments of the present invention with reference to the accompanying drawings.

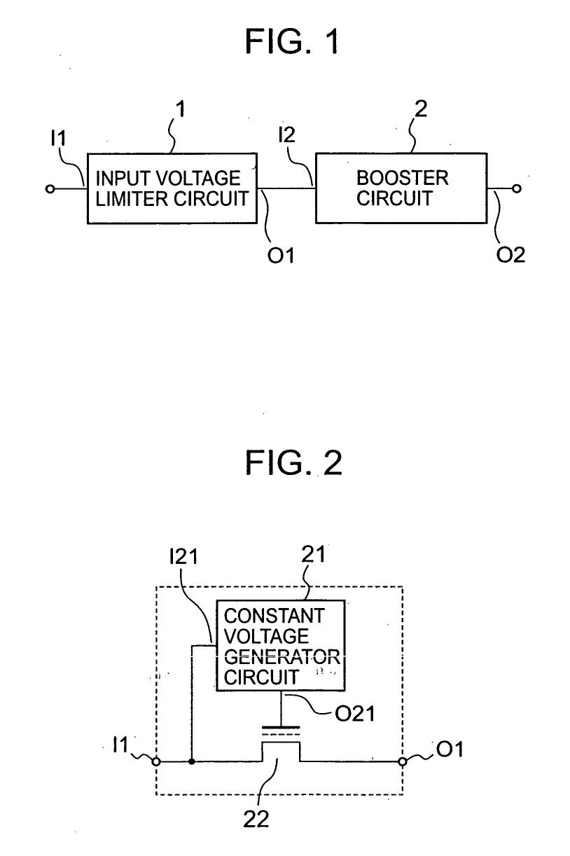

FIG. 1 shows a schematic structure of an electronic circuit according to a first embodiment of the present invention. The electronic circuit includes an input voltage limiter circuit 1 for regulating an upper limit of an input voltage and a booster circuit 2 for boosting an input voltage at a fixed magnification by using a capacitor.

As shown in FIG. 2, the input voltage limiter circuit 1 is constructed of a depletion type MOSFET 22 and a constant voltage generator circuit 21. An input terminal I1 is connected to a power supply terminal D21 of the constant voltage limiter circuit 21 and a drain terminal of the depletion type MOSFET 22. A source terminal of the depletion type MOSFET 22 is connected to an output terminal O1 of the input voltage limiter circuit 1. A gate terminal of the depletion type MOSFET 22 is connected to an output terminal O21 of the constant voltage generator circuit 21.

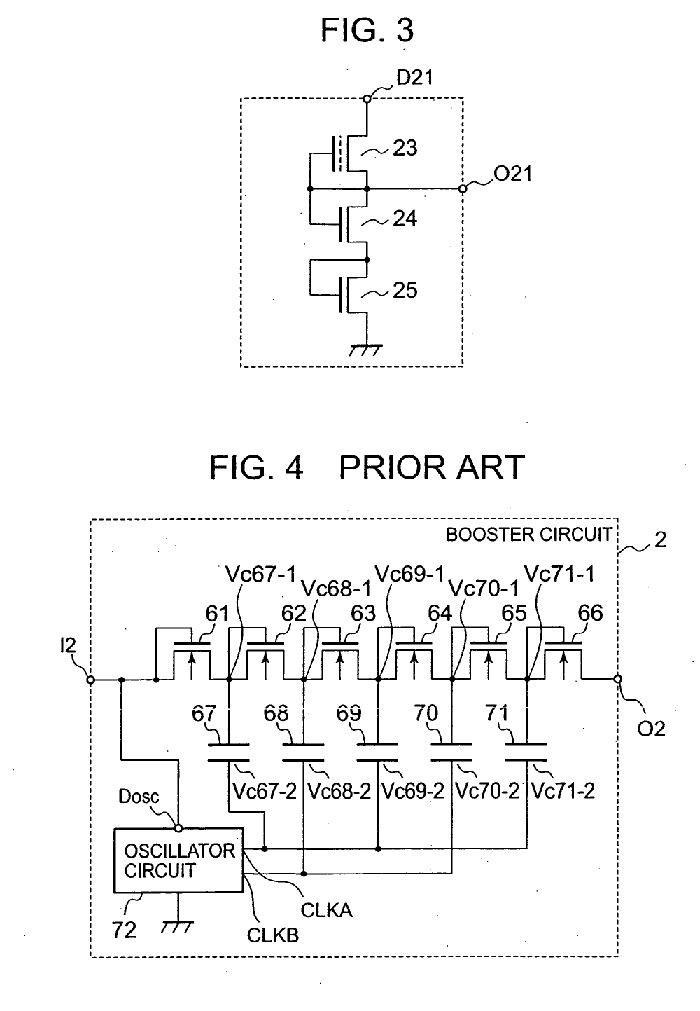

FIG. 3 shows an example of the constant voltage generator circuit 21. The constant voltage generator circuit 21 is constructed of a depletion type MOSFET serving as a constant current element, and an enhancement type MOSFET serving as a resistant element. A power supply terminal D21 of the constant voltage generator circuit 21 is connected to a drain terminal of a depletion type MOSFET 23. A source terminal of the depletion type MOSFET 23 is connected to a gate terminal of the depletion type MOSFET 23, a drain terminal of the enhancement type MOSFET 24, a gate terminal of the enhancement type MOSFET 24, and an output terminal O21 of the constant voltage generator circuit 21. A source terminal of the enhancement type MOSFET 24 is connected to a drain terminal of an enhancement type MOSFET 25 and a gate terminal of the enhancement type MOSFET 25. A source terminal of the enhancement type MOSFET 25 is connected to a ground terminal.

An output voltage of the constant voltage generator circuit 21 becomes |threshold voltage of depletion type MOSFET|+(threshold voltage of enhancement type MOSFET)×(the number of enhancement type MOSFETs). Therefore, the source terminal of the enhancement type MOSFET 25 is further connected with an enhancement type MOSFET as with the enhancement type MOSFET 25, the output voltage of the constant voltage generator circuit 21 can be increased. On the contrary, the enhancement type MOSFET 25 is omitted, and the source terminal of the enhancement type MOSFET 24 is connected to the ground terminal, thereby making it possible to reduce the output voltage of the constant voltage generator circuit 21.

The booster circuit 2 is, for example, a regulator using a coil and a capacitor, or a charge pump system using only a capacitor. In this embodiment, a booster circuit using only a capacitor is employed because the present invention is effective in the boosting operation of constant times.

Hereinafter, a description will be given in more detail of a structure of the charge pump system which is an example of the booster circuit with reference to FIG. 4.

As shown in FIG. 4, the booster circuit of the charge pump system is constructed of an oscillator circuit 72, n-channel MOSFETs 61 to 66, and boost capacitors 67 to 71. The n-channel MOSFETs 61 to 66 are connected with diodes, respectively, and connected in series with one another between the input terminal I2 and the output terminal O2 of the booster circuit 2 such that a forward direction is directed from the input terminal I2 toward the output terminal O2. A node between the n-channel MOSFET 61 and the n-channel MOSFET 62 is connected with one electrode of the boost capacitor 67, a node between the n-channel MOSFET 62 and the n-channel MOSFET 63 is connected with one electrode of the boost capacitor 68, a node between the n-channel MOSFET 63 and the n-channel MOSFET 64 is connected with one electrode of the boost capacitor 69, a node between the n-channel MOSFET 64 and the n-channel MOSFET 65 is connected with one electrode of the boost capacitor 70, and a node between the n- channel MOSFET 65 and the n-channel MOSFET 66 is connected with one electrode of the boost capacitor 71, respectively. The other electrodes of the boost capacitors 67, 69, and 71 are connected to a clock A terminal CLKA of the oscillator circuit 72, and the other electrodes of the boost capacitors 68 and 70 are connected to a clock B terminal CLKB of the oscillator circuit 72. A clock signal A that is on duty of 50% is outputted from the clock A terminal CLKA of the oscillator circuit 72, and a clock signal B that is shifted in phase from the clock signal A by 180 degrees and completely identical in other conditions with the clock signal A is outputted from the clock B terminal CLKB of the oscillator circuit 72. A power supply terminal Dosc of the oscillator circuit 72 is connected to the input terminal I2 of the booster circuit 2. Frequencies of the clock signal A and the clock signal B which are outputted by the oscillator circuit 72 are set to about 1 MHz, and the boost capacitors 67 to 71 are set to about 100 pF. Therefore, the boost capacitors 67 to 71 can be formed within the same chip as that of the n-channel MOSFETs 61 to 66 and the oscillator circuit 72.

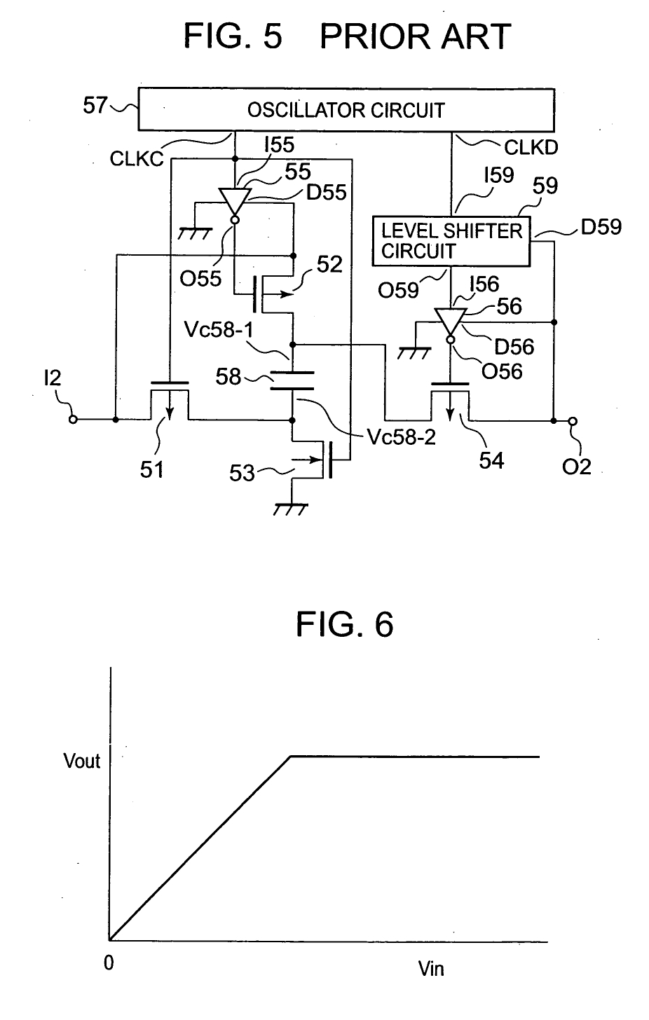

In addition, a description will be given in more detail of a structure of a switched capacitor system as one example of the booster circuit with reference to FIG. 5. The switched capacitor system booster circuit repeatedly connects capacitors to one another or the capacitor and a power supply to each other alternatively in parallel and in series, to thereby boost an input voltage. The switched capacitor system booster circuit is constructed of an oscillator circuit 57, MOSFETs 51 to 54, inverters 55 and 56, a level shifter circuit 59, and a capacitor 58. An input terminal I2 of the booster circuit are connected to the drain terminals of the p-channel MOSFETs 51 and 52, and a source terminal of the p-channel MOSFET 51 is connected to one electrode of the capacitor 58 and a drain terminal of the n-channel MOSFET 53. Further, the other electrode of the capacitor 58 is connected to a source terminal of the p-channel MOSFET 52 and a drain terminal of the p-channel MOSFET 54. A source terminal of the n-channel MOSFET 53 is grounded. A source terminal of the p-channel MOSFET 54 is connected to an output terminal O2 of the booster circuit 2. A gate terminal of the p-channel MOSFET 51, a gate terminal of the n-channel MOSFET 53, and an input terminal 155 of the inverter I55 are connected to a clock C terminal CLKC of the oscillator circuit 57. An input terminal 159 of the level shifter circuit 59 is connected to a clock D terminal CLKD of the oscillator circuit 57. An output terminal O55 of the inverter 55 is connected to a gate terminal of the p-channel MOSFET 52, an output terminal O59 of the level shifter circuit 59 is connected to an input terminal I56 of the inverter 56, an output terminal O56 of the inverter 56 is connected to a gate terminal of the p-channel MOSFET 54. A power supply terminal D55 of the inverter 55 is connected to an input terminal I2 of the booster circuit 2, and a power supply terminal D56 of the inverter 56 and a power supply terminal D59 of the level shifter circuit 59 are connected to the output terminal O2 of the booster circuit 2.

The source terminal of the p-channel MOSFET 54 has a boosted voltage, and thus the boosted voltage must be made identical with the voltage at the output terminal O2 in order to turn off the p-channel MOSFET 54. However, the pulse signal CLKD outputted from the oscillator circuit 57 has a voltage of high which is half the voltage at the output terminal O2. Accordingly, it is possible to convert a voltage of the high signal into a voltage of the output terminal O2 by connecting the level shifter circuit 59 to the terminal of the pulse signal CLKD.

In this example, the double boosting circuit is described. Alternatively, it is also possible to make the multiple number of boost three times, four times, etc., by increasing the number of capacitors or connecting the booster circuits shown in FIG. 5 in cascade.

The electronic device connected as described above operates as follows.

A voltage applied to the input terminal I1 of the electronic circuit 2 is applied to the drain terminal of the depletion type MOSFET 22 and the power supply terminal of the constant voltage generator circuit 21 in the input voltage limiter circuit 1.

FIG. 6 shows characteristics obtained by evaluating the voltage that is applied to the drain terminal of the depletion type MOSFET 22 and the voltage that is outputted to the source terminal thereof. The depletion type MOSFET 22 outputs the voltage that has been applied to the drain terminal to the source terminal substantially as it is. However, when a voltage that is equal to or higher than a given set value is applied to the drain terminal, the depletion type MOSFET 22 holds the voltage of the given set value and outputs the voltage to the source terminal. When the given voltage is applied to the gate terminal of the depletion type MOSFET, the characteristics shown in FIG. 6 are obtained. For that reason, it is possible to increase or decrease the set value by adjusting the voltage outputted from the constant voltage generator circuit 21. In this embodiment of the present invention, when the set value is set to a voltage or lower (withstand voltage) which leads to a damage caused to the MOSFET which constitutes the booster circuit 2, even if the input voltage is higher than the withstand voltage of the MOSFET that constitutes the booster circuit 2, the voltage of the set value (= withstand voltage of the MOSFET that constitutes the booster circuit 2) is outputted to the output of the input voltage limiter circuit 1. The constant voltage generator circuit 21 adjusts the voltage that is to be applied to the gate terminal of the depletion type MOSFET 22 such that the output of the input voltage limiter circuit 1 is equal to or lower than the withstand voltage of the MOSFET which constitutes the booster circuit 2. The adjustment of the voltage is conducted by increasing or decreasing the number of cascade connections of the enhancement type MOSFETs shown in FIG. 3.

The voltage outputted from the input voltage limiter circuit 1 is applied to the input terminal I2 of the booster circuit 2. The operation of the booster circuit 2 is different depending on whether the booster circuit 2 adopts the charge pump system shown in FIG. 4 or the switched capacitor system shown in FIG. 5. In the charge pump system, electric charges that are supplied to the input terminal I2 are charged to the capacitors 67 to 71 through the MOSFETs 61 to 35. At this time, the potential Vc 67-1 of one electrode of the capacitor 67 is (input voltage)−Vf. In this example, Vf is an amount of diode drop across the MOSFETs 61 to 66. Then, when the potential Vc 67-2 of one electrode of the capacitor 67 is increased as much as the crest value (as much as voltage) of the pulse signal by the pulse signal CLKA, the potential Vc 67-1 of the other electrode of the capacitor 67 becomes (input voltage)−Vf+ (crest value of pulse signal). In this situation, because one electrode of the capacitor 38 is connected to the pulse signal CLKB that is different from the pulse signal CLKA in phase by 180 degrees, the potential Vc 38-2 of one electrode of the capacitor 38 is at low level (level close to the ground potential). Therefore, the potential V38-1 of one electrode of the capacitor 38 becomes a value as much as the diode drop of the MOSFET 32 from the voltage that has been sent from the capacitor 67, that is, ((input voltage)−Vf+(crest value of pulse signal))−Vf.

Further, in a subsequent step, when the pulse signal CLKB changes to be at the high level, and the potential V38-2 of one electrode of the capacitor 38 increases as much as the crest value of the pulse signal (as much as the voltage), the potential Vc 38-1 of the other electrode of the capacitor 38 becomes ((input voltage)−Vf+(crest value of pulse signal))−Vf+ (crest value of pulse signal). Subsequently, the above operation is repeated, and the electric charges that have been charged in the capacitor are increased in voltage and sent to a subsequent capacitor. In the electronic circuit shown in FIG. 4, the voltage of the output terminal O2 becomes (input voltage)−6×Vf+5× (crest value of pulse signal).

Then, in a case of the switched capacitor system, the electric charges supplied to the input terminal I2 are applied to the source terminals of the MOSFETs 51 and 52. In this example, when the pulse signal CLKC of the oscillator circuit 57 is the high signal, the p-channel MOSFET 51 is turned off, the p-channel MOSFET 52 is turned on since the clock signal is supplied to the gate terminal thereof through the inverter 55, and the n-channel MOSFET 53 is turned on. In this situation, since the pulse signal CLKD is different from the pulse signal CLKC in phase by 180 degrees, the pulse signal CLKD is the low signal. Accordingly, the gate voltage of the p-channel MOSFET 54 is high since the gate voltage passes through the level shifter circuit 59 and the inverter 56, and the p-channel MOSFET 54 is turned off. Therefore, the capacitor 58 has one electrode connected to the input terminal I2, and the other electrode connected to the ground terminal, thereby making it possible to charge the input voltage.

Then, when the pulse signal CLKC of the oscillator circuit 57 is the low signal, the p-channel MOSFET 51 is turned on, the p-channel MOSFET 52 is turned off since the clock signal is supplied to the gate terminal through the inverter 55, and the n-channel MOLSFET 53 is turned off. In this situation, the pulse signal CLKD is different from the pulse signal CLKC in phase by 180 degrees, so the pulse signal CLKD is the high signal. Accordingly, the gate voltage of the p-channel MOSFET 54 is low since the gate voltage passes through the level shifter circuit 59 and the inverter 56, and the p-channel MOSFET 54 becomes on. Therefore, because the capacitor 58 has one electrode connected to the input terminal I2 and the other electrode connected to the output terminal O2, the voltage that is twice as much as the input voltage can be outputted to the output terminal O2.

A description will be given of specific use examples of the electronic circuit structured as described above according to this embodiment.

The electronic circuit according to this embodiment is applied to a booster circuit of a power production source in which a power supply that is connected to the input terminal I1 largely changes according to the environments such as a natural energy, to thereby enhance the effects of the present invention. In the booster circuit having a natural energy source such as light, heat, or the quantity of motion as the power supply, there are many cases in which the booster circuit for boosting the voltage at a fixed magnification by using the capacitor is more suitable than a switching regulator using a coil. In the case of using the switching regulator, an internal resistor of the natural energy source is large, and there is a fear that a current continues to be supplied from the power production source until an intended voltage is outputted, leading to a reduction in the output voltage of the power production source. When the fixed magnification is applied, there is no fear that the output voltage of the power production source is reduced, and the boosted voltage can be constantly extracted. However, the problem with the conventional art is that when a voltage that is higher than an expected voltage is inputted as the input voltage, the input voltage exceeds the withstand voltage of the MOSFET that constitutes the booster circuit in a process of the boosting operation, resulting in causing damage to the circuit. The present invention is to improve the drawbacks at the time of using the booster circuit with the fixed magnification.

Also, the electronic circuit according to this embodiment is suitable for a case in which the booster circuit is constructed of MOSFETs using a fine process, or SOI MOSFETs where a device is formed on a very thin silicon layer. Those devices are not only low in the withstand voltage of the MOSFET but also larger in the leak current than the conventional MOSFETs. An increase in the leak current brings the instability of the electronic circuit if not the damage of the MOSFET. In this embodiment, the voltage applied to the booster circuit is suppressed, and therefore the stable operation can be conducted with the low consumption with a minimum useless leak current.

### SECOND EMBODIMENT

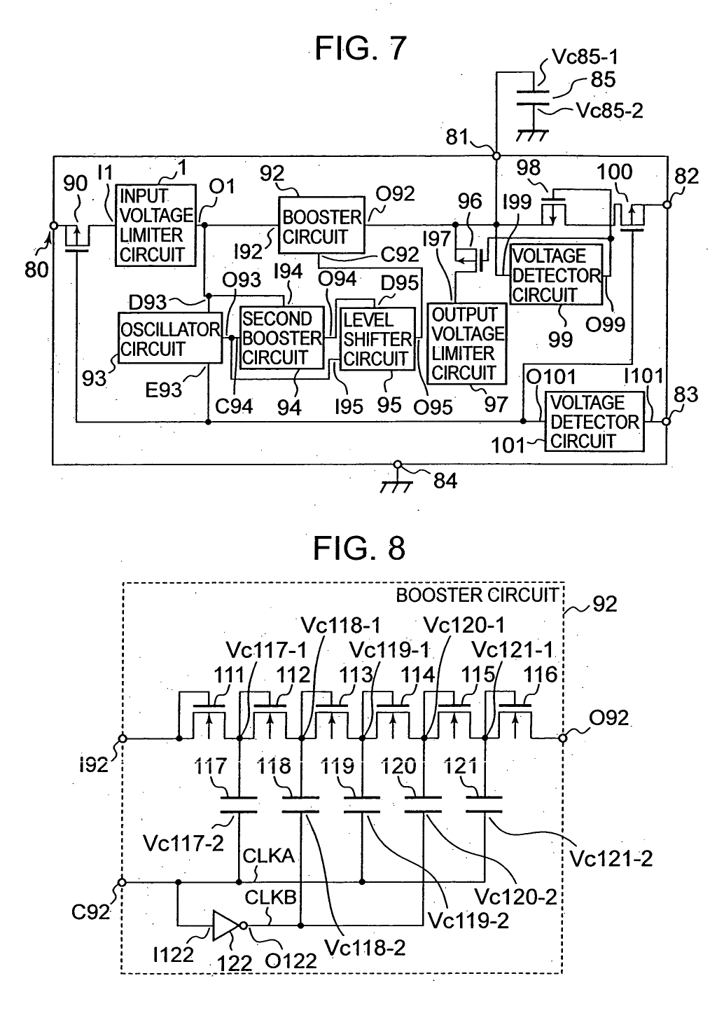

Now, a description will be given of a case in which there are fixed magnification booster circuits having different boost magnifications within one circuit according to another embodiment of the present invention with reference to FIG. 7.

FIG. 7 shows a schematic structure of an electronic circuit according to another embodiment of the present invention. The electronic circuit includes a p-channel MOSFET 90 for cutting wastes in current consumption when the electronic circuit stands by, an input voltage limiter circuit 1 for regulating a upper limit of an output voltage, a booster circuit 92 for boosting the input voltage at a fixed magnification by using a capacitor, an oscillator circuit 93 for supplying a clock signal to the booster circuit 92, a second booster circuit 94 for generating a voltage required to increase an amplitude of the clock signal, and a level shifter circuit 95 that combines the clock signal with the output voltage of the second booster circuit 94 to produce a clock signal that is large in amplitude. The electronic circuit also includes an output voltage limiter circuit 97 for regulating an upper limit of the output voltage of the booster circuit 92, a p-channel MOSFET 96 for turning on/off the operation of the output voltage limiter circuit 97, a capacitor 85 for charging the output of the booster circuit 92, and a p-channel MOSFET 98 that is a switch required for outputting the electric charges charged in the capacitor 85 from the output terminal 82 to outside. The electronic circuit further includes a voltage detector circuit 99 for monitoring the voltage across the capacitor 85 and transmits a signal to the p-channel MOSFET 98 when the monitored voltage is equal to or higher than a set value, a p-channel MOSFET 100 for cutting wastes in current consumption that flows from the output terminal 82 when the electronic circuit stands by, and a voltage detector circuit 101 for monitoring the external voltage and outputs a signal of a standby mode when the external voltage is equal to or higher than the set value.

The p-channel MOSFET 90 operates to cut wastes in current consumption when the electronic circuit stands by. An n-channel MOSFET or other switches for conducting on/off operation may be used besides the p-channel MOSFET.

As shown in FIG. 2, the input voltage limiter circuit 1 is constructed of the depletion type MOSFET 22 and the constant voltage generator circuit 21. The input terminal I1 is connected to the power supply terminal D21 of the constant voltage generator circuit 21 and the drain terminal of the depletion type MOSFET 22. The source terminal of the depletion type MOSFET 22 is connected to the output terminal O1 of the input voltage limiter circuit 2. The gate terminal of the depletion type MOSFET 22 is connected to the output terminal O21 of the constant voltage generator circuit 21. In this example, the circuit shown in FIG. 2 is described. Alternatively, there may be applied a voltage limiting method in which a zener diode is connected between the input terminal I1 and the GND terminal, and the voltage is allowed to escape to the GND through the zener diode in a case where a voltage that is equal to or higher than the set voltage is applied.

As shown in FIG. 8, the booster circuit 92 is constructed of n-channel MOSFETs 111 to 116, boost capacitors 117 to 121, and an inverter 122 by using the booster circuit of the charge pump system. The n-channel MOSFETs 111 to 116 are connected with diodes, respectively, and connected in series with one another between the input terminal I92 and the output terminal O92 of the booster circuit 92 such that a forward direction is directed from the input terminal I92 toward the output terminal O92 . A node between the n-channel MOSFET 111 and the n-channel MOSFET 112 is connected with one electrode of the boost capacitor 117, a node between the n-channel MOSFET 112 and the n-channel MOSFET 113 is connected with one electrode of the boost capacitor 118, a node between the n-channel MOSFET 113 and the n-channel MOSFET 114 is connected with one electrode of the boost capacitor 119, a node between the n-channel MOSFET 114 and the n-channel MOSFET 115 is connected with one electrode of the boost capacitor 120, and a node between the n-channel MOSFET 115 and the n-channel MOSFET 116 is connected with one electrode of the boost capacitor 121, respectively. The other electrodes of the boost capacitors 117, 119, and 121 are connected to a clock A line CLKA which is connected to a clock terminal C92 of the booster circuit 92, and the other electrodes of the boost capacitors 118 and 120 are connected to a clock B line CLKB which is connected to the clock terminal C92 of the booster circuit 92 through the inverter 122. The clock terminal C92 of the booster circuit 92 is a terminal to which the clock signal outputted from the level shifter circuit 95 is applied. The inverter 112 has the input terminal I122 connected to the clock terminal C92 of the booster circuit 92, and the output terminal O122 connected to the other electrodes of the boost capacitors 118 and 120, to output a signal that is shifted from the clock A line CLKA in phase by 180 degrees. The frequency of the clock signal is set to about 1 MHz, and the boost capacitors 117 to 121 are set to about 100 pF. Therefore, the boost capacitors 117 to 121 can be formed within the same chip as that of the n-channel MOSFETs 111 to 116 and the inverter 122. In this example, the booster circuit of the charge pump system is described as the booster circuit 92. Alternatively, a booster circuit of the switched capacitor system may be used.

The oscillator circuit 93 supplies a clock signal to the second booster circuit 94 and the level shifter circuit 95. The oscillator circuit 93 is a ring oscillator circuit that is constructed of an inverter and a capacitor. A clock signal that is on duty of 50% is outputted from an output terminal O93 of the oscillator circuit 93. A power supply terminal D93 of the oscillator circuit 93 is connected to the output terminal O1 of the input limiter circuit 1. The inverter and the capacitor are adjusted in such a manner that the frequency of the clock signal that is outputted by the oscillator circuit 92 becomes about 1 MHz. Also, the oscillator circuit 93 is equipped with a clock signal output control terminal E93, and the operation of the oscillator circuit 93 can be stopped according to a signal that is outputted from the voltage detector circuit 101. In other words, a clock signal of 1 MHz can be outputted or not outputted from the output terminal O93 of the oscillator circuit 93 depending on a signal that is outputted from the voltage detector circuit 101. In this example, the ring oscillator circuit is used as the oscillator circuit. Alternatively, an oscillator circuit using a piezoelectric material or an oscillator circuit that is combined with a logic circuit may also be used.

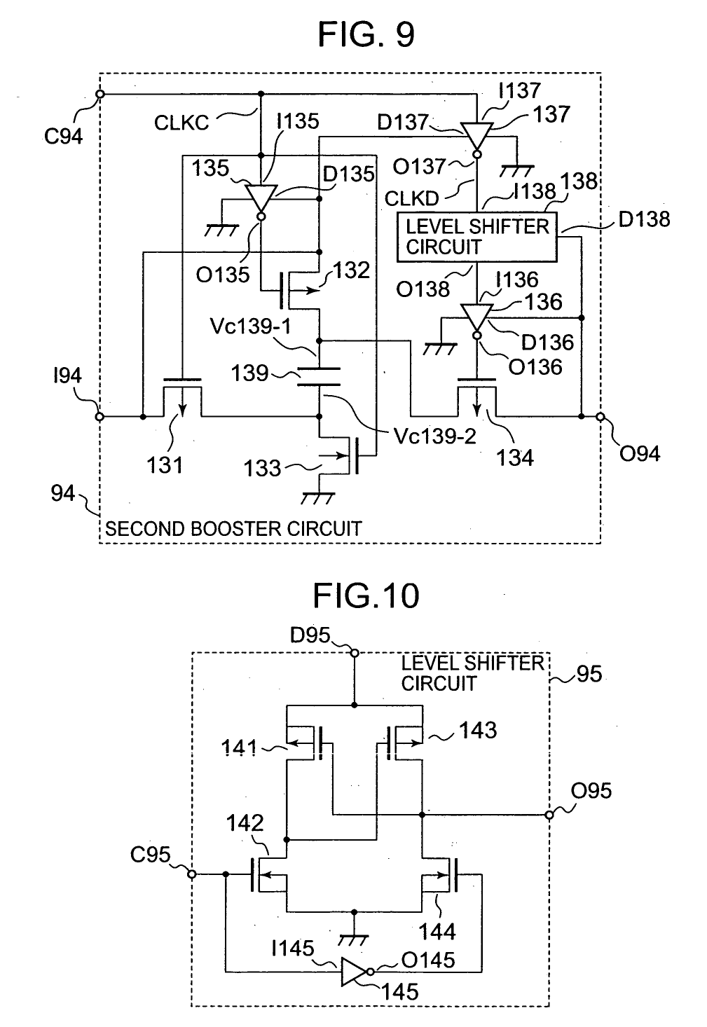

The second booster circuit 94 boosts the output voltage of the input voltage limiter circuit 1 according to the clock signal outputted from the oscillator circuit 93, and supplies an electric power to the power supply terminal D95 of the level shifter circuit 95. The second booster circuit 94 is constructed of a booster circuit of the switched capacitor system shown in FIG. 9. The switched capacitor system booster circuit repeatedly connects the capacitors with each other, or the capacitor with the power supply alternatively in the parallel or in series, thereby making it possible to boost the input voltage.

The switched capacitor system booster circuit is constructed of MOSFETs 131 to 134, inverters 135 to 137, a level shifter circuit 138, and a capacitor 139. An input terminal 194 of the second booster circuit 94 is connected to the drain terminals of the p-channel MOSFETs 131 and 132, and the source terminal of the p-channel MOSFET 131 is connected to one electrode of the capacitor 139 and the drain terminal of the n-channel MOSFET 133. In addition, the other electrode of the capacitor 139 is connected to the source terminal of the p-channel MOSFET 132 and the drain terminal of the p-channel MOSFET 134. The source terminal of the n-channel MOSFET 133 is grounded. The source terminal of the p-channel MOSFET 134 is connected to an output terminal O94 of the second booster circuit 94. The gate terminal of the p-channel MOSFET 131, the gate terminal of the n-channel MOSFET 133, an input terminal I135 of the inverter 135, and an input terminal I137 of the inverter 137 are connected to a clock terminal C94 of the second booster circuit 94. An output terminal O135 of the inverter 135 is connected to the gate terminal of the p-channel MOSFET 132, an output terminal O137 of the inverter 137 is connected to an input terminal I138 of the level shifter circuit 138, an output terminal O138 of the level shifter circuit 138 is connected to an input terminal I136 of the inverter 136, and an output terminal O136 of the inverter 136 is connected to the gate terminal of the p-channel MOSFET 134. The power supply terminal D55 of the inverter 135 and the power supply terminal D137 of the inverter 137 are connected to an input terminal I94 of the second booster circuit 94, and the power supply terminal D56 of the inverter 136 and the power supply terminal D138 of the level shifter circuit 138 are connected to the output terminal O94 of the second booster circuit 94.

The level shifter circuit 95 combines the clock signal outputted from the oscillator circuit 93 with the output voltage of the second booster circuit 94 to produce a clock signal that is large in amplitude. As shown in FIG. 10, the level shifter circuit 95 is constructed of the p-channel MOSFETs, the n-channel MOSFETs, and an inverter. A clock terminal C95 of the level shifter circuit 95 is connected to the gate terminal of an n-channel MOSFET 142 and an input terminal I145 of an inverter 145. An output terminal O145 of the inverter 145 is connected to the gate terminal of the n-channel MOSFET 144, and the source terminals of the n-channel MOSFETs 142 and 144 are grounded. The power supply terminal D95 of the level shifter circuit 95 is connected to the source terminals of the p-channel MOSFETs 141 and 143, and the drain terminal of the p-channel MOSFET 141 is connected to the drain terminal of the n-channel MOSFET 142 and the gate terminal of the p-channel MOSFET 143. Then, the drain terminal of the p-channel MOSFET 143 is connected to the drain terminal of the n-channel MOSFET 144, the gate terminal of the p-channel MOSFET 141, and the output terminal O95 of the level shifter circuit 95.

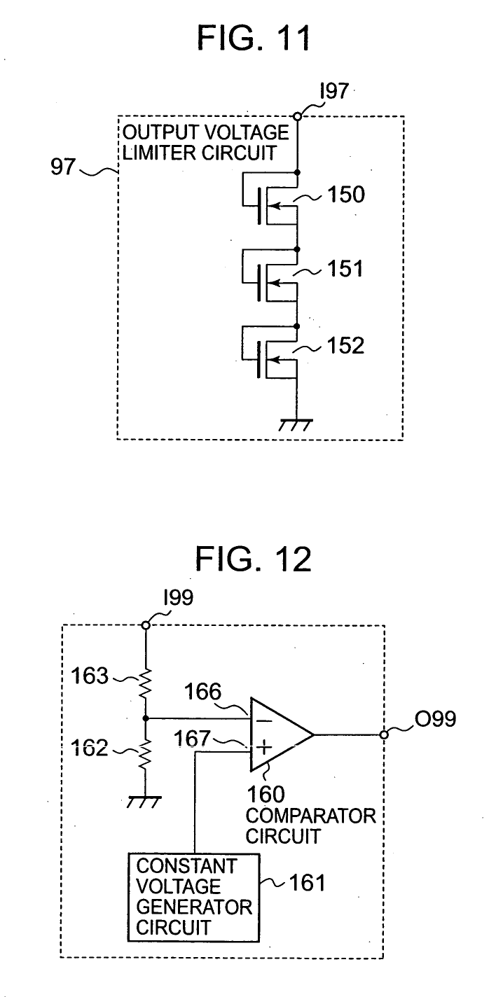

The output voltage limiter circuit 97 allows the electric charges to escape to the ground terminal when the output voltage of the booster circuit 92 is increased to be equal to or higher than a set value to prevent the output voltage of the booster circuit 92 from increasing to the set value or higher. The input voltage limiter circuit according to this embodiment is constructed of a plurality of n- channel MOSFETs as shown in FIG. 11. An input terminal I97 of the output voltage limiter circuit 97 is connected to the gate terminal and the drain terminal of an n-channel MOSFET 150, and the source terminal of the n-channel MOSFET 150 is connected to the gate terminal and the drain terminal of an n-channel MOSFET 151, and the drain terminal of an n-channel MOSFET 152 is grounded. In this example, three blocks each having the drain terminal and the gate terminal of the n-channel MOSFET connected to each other are connected in cascade. The number of cascade connections is varied according to the set output voltage limit value. In this embodiment, the n-channel MOSFETs are employed. Alternatively, a zener diode may be used to obtain the same effects.

The p-channel MOSFET 96 turns on/off the operation of the input voltage limiter circuit 97. The p-channel MOSFET may be replaced by an n-channel MOSFET or another switch that conducts the on/off operation.

The capacitor 85 stores a voltage that has been boosted by the booster circuit 92 therein.

The voltage detector circuit 99 monitors the voltage across the capacitor 85, and outputs a signal when the voltage across the capacitor 85 becomes equal to or higher than the set voltage to turn on the p-channel MOSFETs 96 and 98. As shown in FIG. 12, the voltage detector circuit 99 is composed of a comparator circuit, a constant voltage generator circuit, and a resistor. An input terminal 199 of the voltage detector circuit 99 is connected to one terminal of a resistor 163, and the other terminal of the resistor 163 is connected to a first input terminal 166 of the comparator, and one end of a resistor 162. The other end of the resistor 162 is grounded. A second input terminal 167 of the comparator is connected to the output of a constant voltage generator circuit 161. An output terminal of the comparator circuit 160 is connected to an output terminal O99 of the voltage detector circuit 99.

Upon receiving a signal outputted from the voltage detector circuit 99, the p-channel MOSFET 98 outputs the electric charges that are stored in the capacitor 85 to the output terminal of the electronic circuit. The p-channel MOSFET may be replaced by an n-channel MOSFET or another switch that conducts the on/off operation.

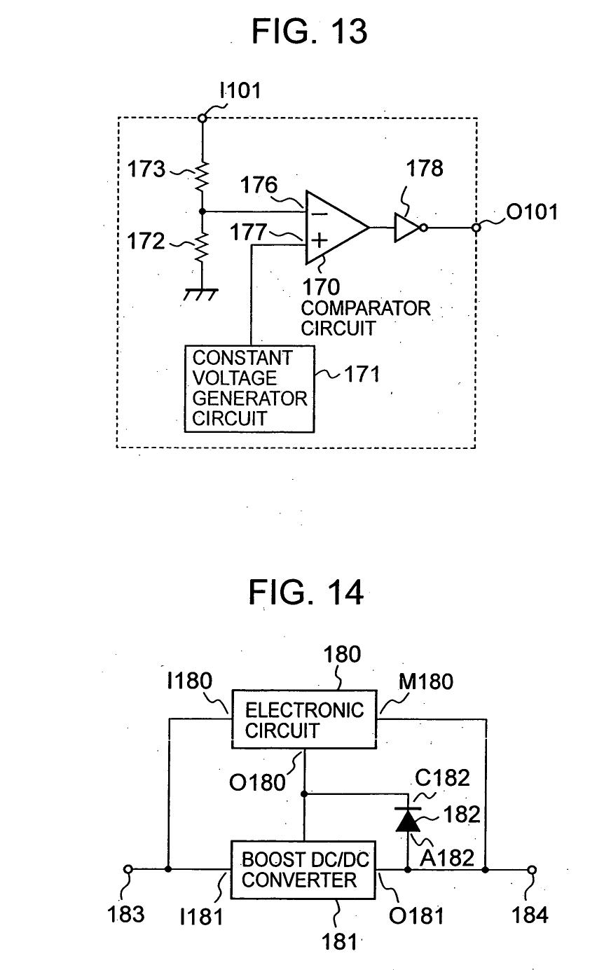

The voltage detector circuit 101 monitors the voltage outside, and outputs a signal when the voltage becomes equal to or higher than the set voltage to turn off the p-channel MOSFETs 90 and 100. As shown in FIG. 13, the voltage detector circuit 101 is composed of a comparator circuit, a constant voltage generator circuit, a resistor, and an inverter. An input terminal I101 of the voltage detector circuit 101 is connected to one terminal of a resistor 173, and the other terminal of the resistor 173 is connected to a first input terminal 176 of the comparator, and one end of a resistor 172. The other end of the resistor 172 is grounded. A second input terminal 177 of the comparator is connected to the output of a constant voltage generator circuit 171. An output terminal of the comparator circuit 170 is connected to an output terminal of the inverter 178, and an output terminal of the inverter 178 is connected to an output terminal O101 of the voltage detector circuit 101.

Upon receiving a signal that is outputted from the voltage detector circuit 100, the p-channel MOSFET 100 blocks the output terminal 82 of the electronic circuit and the p-channel MOSFET, and prevents a current from flowing from the output terminal 82 of the electronic circuit when the electronic circuit is in a standby mode. The p-channel MOSFET may be replaced by an n-channel MOSFET or another switch that conducts the on/off operation.

A description will be given of the connection of the electronic circuit that is composed of the above-mentioned circuit blocks.

An input terminal 80 of the electronic circuit is connected to the source terminal of the p-channel MOSFET 90, and the drain terminal of the p-channel MOSFET 90 is connected to an input terminal I1 of the input limiter circuit 1. An output terminal O1 of the input limiter circuit 1 is connected to an input terminal 194 of the second booster circuit 94, the power supply terminal D93 of the oscillator circuit 93, and an input terminal I94 of the second booster circuit 94. The output terminal O93 of the oscillator circuit 93 is connected to the clock terminal C94 of the second booster circuit 94 and an input terminal I95 of the level shifter circuit 95. The output terminal O94 of the second booster circuit 94 is connected to the power supply terminal D95 of the level shifter circuit 95. The output terminal O95 of the level shifter circuit 95 is connected to the clock terminal C92 of the booster terminal 92. The output terminal O92 of the booster circuit 92 is connected to the source terminal of the p-channel MOSFET 96, one electrode Vc 85-1 of the capacitor 85, the source terminal of the p-channel MOSFET 98, and the input terminal I99 of the voltage detector circuit 99. The drain terminal of the p-channel MOSFET 96 is connected to the input terminal I97 of the output voltage limiter circuit 97, and the other electrode Vc 85-2 of the capacitor 85 is grounded. The drain terminal of the p-channel MOSFET 98 is connected to the drain terminal of the p-channel MOSFET 100, and the source terminal of the p-channel MOSFET 100 is connected to the output terminal 82 of the electronic circuit. The output terminal O99 of the voltage detector circuit 99 is connected to the gate terminals of the p-channel MOSFETs 98 and 97, and an external monitor terminal 83 of the electronic circuit is connected to an input terminal I101 of the voltage detector circuit 101. Then, the output terminal O101 of the voltage detector circuit 101 is connected to the p-channel MOSFETs 90 and 100, and to the clock signal output control terminal E93 of the oscillator circuit 93.

The electronic circuit connected as described above operates as follows. When no voltage is applied to the external monitor terminal, the p-channel MOSFETs 90 and 100 are turned on. When a voltage is applied to the input terminal 80 of the electronic circuit, the voltage is applied to the drain terminal of the depletion type MOSFET 22 and the power supply terminal of the constant voltage generator circuit 21 in the input voltage limiter circuit 1.

The characteristics shown in FIG. 6 are obtained by evaluating the voltage that is applied to the drain terminal of the depletion type MOSFET 22 and the voltage that is outputted to the source terminal thereof. The depletion type MOSFET 22 outputs the voltage that has been applied to the drain terminal to the source terminal substantially as it is. However, when a voltage that is equal to or higher than a given set value is applied to the drain terminal, the depletion type MOSFET 22 holds the voltage of the given set value and outputs the voltage to the source terminal. When the given voltage is applied to the gate terminal of the depletion type MOSFET, the characteristics shown in FIG. 6 are obtained. For that reason, the voltage that is outputted by the constant voltage generator circuit 21 is adjusted, thereby making it possible to increase or decrease the set value. In this embodiment of the present invention, when the set value is set to be equal to or lower than a voltage (withstand voltage) which causes the damage of the MOSFETs which that constitute the oscillator circuit 93 and the second booster circuit 94, even when the input voltage is higher than the withstand voltage of the MOSFET that constitutes the oscillator circuit 93 and the second booster circuit 94, the voltage of the set value (=withstand voltage of the MOSFET that constitutes the booster circuit 2) is outputted to the output of the input voltage limiter circuit 1. The constant voltage generator circuit 21 adjusts the voltage that is applied to the gate terminal of the depletion type MOSFET 22 so that the output of the input voltage limiter circuit 1 is equal to or lower than the withstand voltage of the MOSFET which constitutes the oscillator circuit 93 and the second booster circuit 94. The adjustment of the voltage is conducted by increasing or decreasing the number of cascade connections of the enhancement type MOSFETs shown in FIG. 3.

The voltage that has been outputted from the input voltage limiter circuit 1 is applied to the input terminal I92 of the booster circuit 92, the power supply terminal D93 of the oscillator circuit 93, and the input terminal I94 of the second booster circuit 94. When the voltage is first applied to the oscillator circuit 93, the oscillator circuit 93 starts to operate, and outputs the clock signal of the on duty 50% from the output terminal O93 of the oscillator circuit 93. Upon receiving the outputted clock signal, the second booster circuit 94 starts to operate.

The operation of the second booster circuit 94 is conducted in such a manner that when the high pulse signal is inputted to the clock terminal C94 of the second booster circuit 94, the p-channel MOSFET 132 and the n-channel MOSFET 133 turn on, and the capacitor 139 is charged with the electric charges. Then, when the low pulse signal is inputted to the clock terminal C94 of the second booster circuit 94, the p-channel MOSFETs 131 and 134 turn on, (input voltage)+(voltage charged in the capacitor 139) is outputted to the output terminal O94 of the second booster circuit 94. Therefore, the outputted voltage is about twice as much as the voltage that has been inputted to the second booster circuit 94. When the voltage that is twice as much as the voltage that has been applied to the input terminal 80 of the electronic circuit is developed by the second booster circuit 94, this voltage and the clock signal that has been outputted from the oscillator circuit 93 are multiplied together by the level shifter circuit 95, and a clock signal that has a crest value which is twice as much as the voltage that has been applied to the input terminal 80 of the electronic circuit, and has the frequency which is the frequency of the clock that has been outputted from the oscillator circuit 93 is outputted from the level shifter circuit 95.

The booster circuit 92 starts to operate according to the clock signal that has been outputted from the level shifter circuit 95, and boosts the voltage that has been outputted from the input voltage limiter circuit 1.

In the charge pump system used in the booster circuit 92, the electric charges that have been supplied to the input terminal I92 are charged in the capacitors 117 to 121 through the MOSFETS 111 to 115. In this case, the potential Vc 117-1 of one electrode of the capacitor 117 is (input voltage)−Vf. In this example, Vf is as much as the diode drop in the MOSFETs 111 to 116. Then, when the pulse signal CLKA increases the potential Vc 117-2 of one electrode of the capacitor 117 by as much as the crest value (as much as voltage) of the pulse signal, the potential Vc 311-1 of the other electrode of the capacitor 117 becomes (input voltage)−Vf+ (crest value of the pulse signal). In this case, because one electrode of the capacitor 118 is connected to the pulse signal CLKB that is different from the pulse signal CLKA in phase by 180 degrees, the potential Vc 118-2 of one electrode of the capacitor 118 is at the low level (level close to the ground potential). Therefore, the potential V 118-1 of one electrode of the capacitor 118 becomes a value as much as the diode drop of the MOSFET 112 from the voltage that has been transmitted from the capacitor 117, that is, ((input voltage)−Vf+ (crest value of pulse signal))−Vf.

Further, as a subsequent step, when the pulse signal CLKB changes to the high level, and the potential V118-2 of one electrode of the capacitor 118 increases as much as the crest value of the pulse signal (as much as the voltage), the potential Vc 118-1 of the other electrode of the capacitor 118 becomes ((input voltage)−Vf+ (crest value of pulse signal))−Vf+ (crest value of pulse signal). Subsequently, the above operation is repeated, and the electric charges that have been charged in the capacitor are sent to a subsequent capacitor while increasing the voltage. In the electronic circuit shown in FIG. 8, the voltage of the output terminal O92 becomes (input voltage)−6×Vf+5× (crest value of pulse signal).

The electric charges that have been boosted by the booster circuit 92 are stored in the capacitor 85. When the electric charges are stored in the electric charges, the voltage across the capacitor 85 gradually increases. Since the voltage across the capacitor 85 is always monitored by the voltage detector circuit 99, a signal is outputted from the output terminal O99 of the voltage detector circuit 99 when the voltage across the capacitor 85 exceeds the set value. The voltage set in this example is a desired voltage that is outputted from the output terminal 82 of the electronic circuit. It is needless to say that this voltage is lower than a voltage that causes the damage of the MOSFET and the capacitor which constitute the electronic circuit.

Upon receiving the signal that has been outputted from the voltage detector circuit 99, the p-channel MOSFETs 96 and 98 are turned on. Because the p-channel MOSFET 100 is first turned on, the electric charges that are stored in the capacitor 85 are outputted from the output terminal 82 of the electronic circuit.

Now, the output voltage control circuit 97 will be described. The output voltage control circuit 97 is constituted such that transistors that are connected with diodes are connected to each other in cascade, and when a high voltage is applied to the circuit, the output voltage limiter circuit 97 enables large current to flow in the ground terminal when the high voltage exceeds a given threshold voltage. For that reason, when the threshold voltage is set to a voltage that is lower than the voltage that causes the damage of the MOSFET or the capacitor which constitutes the electronic circuit, the voltage can be suppressed from increasing by allowing the current to flow. In the booster circuit of the charge pump system, the maximum voltage that is applied to the interior of the booster circuit 92 becomes the voltage of the output terminal O92 of the booster circuit 92. For that reason, it is necessary that the voltage at the output terminal O92 of the booster circuit 92 does not become the voltage that causes the damage of the MOSFET or the capacitor which constitutes the electronic circuit. When the output voltage limiter circuit 97 is connected to the output terminal of the booster circuit 92, the internal circuit can be protected from the high voltage. However, because the output voltage limiter circuit 97 needs to make a large amount of currents flow when a high voltage is applied, the current consumption when the output voltage limiter circuit 97 does not operate is also very large. As a result, even when the electric charges are supplied by the booster circuit 92, the output voltage limiter circuit 97 consumes the electric charges. For that reason, as described above, the output voltage limiter circuit 97 turns on the p-channel MOSFET that turns on/off the operation of the output voltage limiter circuit 97 only after the voltage across the capacitor 85 exceeds the set value, and then conducts the output voltage limit operation.

Then, the voltage detector circuit 101 monitors the external voltage, and when the external voltage exceeds the voltage of the set value, the voltage detector circuit 101 detects the voltage, and turns off the p-channel MOSFETs 90 and 100, and stops the operation of the oscillator circuit 93. This operation is a function of monitoring the external voltage and setting the electronic circuit to a standby mode. In the standby mode, since the operation of the booster circuit 92 is unnecessary, the operation of the oscillator circuit 93 which is a base of the operation of the booster circuit 92 is stopped. In addition, in order to prevent the current that flows from the input terminal 80 and the output terminal 82 of the electronic circuit, the p-channel MOSFETs 90 and 100 are turned off, to thereby suppress the useless power consumption.

A description will be given of another specific example of use of an electronic circuit according to this embodiment structured as described above.

The electronic circuit according to another embodiment is effective in a device that is low in the damage voltage of the MOSFET or the capacitor which constitutes the electronic circuit. In particular, in recent years, because miniaturization has been advanced, and the withstand voltage of the electronic circuit has been lowered, the present invention is effective to the recent electronic circuits.

The electronic circuit shown in FIG. 7 is effective in an intended purpose for triggering the circuit application, particularly when a supply voltage is low and the circuit application cannot be operated. More specifically, a boost DC/DC converter can boost the voltage from a low voltage, but the present invention is effective in the operation trigger of the boost DC/DC converter that requires the high voltage for its own operation. In this case, as a prerequisite for such the boost DC/DC converter, the electronic circuit is capable of operating from the low voltage, and the damage withstand voltage of the MOSFET or the capacitor within the circuit is low. On the other hand, the boost DC/DC converter is high in the withstand voltage and can boost the voltage from the low voltage, and a high voltage is required for its own operation. As shown in FIG. 14, the circuit application is constructed of the electronic circuit 180 shown in FIG. 7, a boost DC/DC converter 181, and a diode 182. An input terminal 183 is connected to an input terminal I180 of the electronic circuit and an input terminal I181 of the boost DC/DC converter 181. An output terminal O180 of the electronic circuit 180 is connected to the power supply terminal D181 of the boost DC/DC converter 181 and a cathode terminal C182 of the diode 182. An output terminal O181 of the boost DC/DC converter 181 is connected to an output terminal 184 and an anode terminal A182 of the diode 182.

In the circuit application connected as described above, when the voltage of the input terminal 183 is low, the boost DC/DC converter 181 cannot operate. However, since the electronic circuit 180 can operate, the boost operation is conducted in the interior of the circuit, and electric charges that are stored in the capacitor are outputted from the output terminal O180 of the electronic circuit 180. Because the outputted voltage is a high voltage, the boost DC/DC converter 181 is capable of starting the boost operation. The boost DC/DC converter 181 that starts the boost operation boosts the voltage of the input terminal 183, and supplies the electric charges to the output terminal 184. In this case, because the output terminal O181 of the boost DC/DC converter 181 is connected to the power supply terminal D181 of the boost DC/DC converter 181 through the diode 182, the boost DC/DC converter 181 is capable of operating itself by using the boosted high voltage. In this case, because the electronic circuit 180 does not need to supply the electric charges to the power supply terminal D181 of the boost DC/DC converter 181, the circuit application monitors the output voltage of the boost DC/DC converter 181 by using the external monitor terminal M180, and sets the electronic circuit 180 to the standby mode when the voltage becomes equal to or higher than the set value. In this case, it is ideal that the electronic circuit 180 does not consume the current, but because the electronic circuit according to this embodiment uses the p-channel MOSFETs 90 and 100, the current consumption at the standby mode can be suppressed to a very small value.

What is claimed is:

1. An electronic device, comprising:
a voltage limiter circuit that is connected to an input terminal and regulates an upper limit of an input voltage which is inputted to the input terminal; and
a booster circuit that is connected to the voltage limiter circuit and boosts the input voltage to a fixed magnification to output the boosted voltage to an output terminal.

2. An electronic circuit according to claim 1, wherein the booster circuit comprises:
a clock generator circuit for generating a clock signal;
a rectifier element; and
a capacitor.

3. An electronic circuit according to claim 2, wherein the rectifier element comprises a MOSFET connected with a diode.

4. An electronic circuit according to claim 1, wherein:
the booster circuit comprises:
a booster unit circuit including a diode or an anode of a MOSFET connected with a diode as an input terminal, and a capacitor having one electrode connected to the diode or a cathode of the MOSFET connected with the diode; and
a clock generator circuit connected to another electrode of the capacitor, and
one of more of the boost unit circuits are provided to be connected in cascade.

5. An electronic circuit according to claim 1, wherein:
the booster circuit has a plurality of booster unit circuits;
the plurality of booster unit circuit has a configuration in which:
a drain of a first MOSFET is connected to a drain of a second MOSFET to form an input terminal;
a source of the first MOSFET is connected to a drain of a third MOSFET and to a first electrode of a capacitor;
a source of the second MOSFET is connected to a second electrode of the capacitor and to a drain of a fourth MOSFET;
a source of the fourth MOSFET is used as an output terminal;
a source of the third MOSFET is grounded;
the gates of the first and third MOSFETs are connected to the clock output terminal of a clock generator circuit;
a gate of the second MOSFET and an input terminal of a level shift circuit are connected to an inverting clock output terminal of a clock generator circuit; and
an output terminal of the level shifter circuit is connected to a gate terminal of the fourth MOSFET; and
the plurality of booster unit circuits are connected in cascade.

6. An electronic circuit according to claim 1, wherein:
the voltage limiter circuit comprises:
a constant voltage generator circuit for inputting the input voltage and outputting a constant voltage; and
a depletion type MOSFET having a gate voltage controlled by the constant voltage outputted from the constant voltage generator circuit.

7. An electronic circuit according to claim 6, wherein:
the constant voltage generator circuit comprises:
a constant current source; and
a resistant element,
the constant current source and the resistant element being connected in series to each other between the input terminal and a ground terminal; and
the input terminal is formed of a connection point at which the constant current source and the resistant element are connected to each other.

8. An electronic circuit according to claim 7, wherein the constant current source comprises a depletion type MOSFET having a gate and a source connected to each other.

9. An electronic circuit according to claim 7, wherein the resistant element comprises a MOSFET connected with a diode.
